(19) United States
(12) Patent Application Publication
(10) Pub. No.: US 2026/0226248 A1
(43) Pub. Date: Aug. 6, 2026

(54) CONVERSION OF POLYURETHANE IN A TAPERED REACTOR

(71) Applicant: NEVEON GERMANY GMBH, Wiesbaden (DE)

(72) Inventors: Herbert BETTINGER, St. Wendel (DE); Asmaa AJARROUD, Hoppstadten-Weiersbach (DE)

(21) Appl. No.: 18/868,934

(22) PCT Filed: May 19, 2023
(86) PCT No.: PCT/EP2023/063454

§ 371 Date: Nov. 25, 2024

(30) Foreign Application Priority Data
May 26, 2022 (DE) 10 2022 113 374.5

(51) Int. Cl. C08J 11/18; C08J 11/14

(52) U.S. Cl. CPC C08J 11/18; C08J 11/14; C08J 2375/04

(57) ABSTRACT

Embodiments of the present disclosure relate to a continuous process for converting a plastic material containing a polyurethane. In some embodiments, the continuous process may include providing a reaction mixture, wherein the reaction mixture comprises a plastic material in solid form and containing a polyurethane, and further an aqueous medium, optionally containing a reaction additive, wherein in the reaction mixture the mass ratio between the water of the aqueous medium and polyurethane is not more than 0.6 to 1 and is pressure-/heat-treated at >1 bar to 60 bar at 180-270° C. in a reactor tapered at least at an end region. The method may further include transporting the reaction mixture under pressure and removal of gaseous components via at least one degassing point and in or after an evaporation zone, and recovery of the reaction mixture which has been pressure- and heat-treated and freed of gaseous components.

The invention relates to a process for converting a polyurethane containing plastic material and a corresponding device.

Due to their many adjustable properties, polyurethanes are widely used in products used in industry or in households. Examples of such products are foams, paints, adhesives, potting compounds, hoses, seals, floor coverings, mattresses, car parts, parts of sports equipment, parts of shoes, and the like.

Therefore, a high proportion of polyurethane waste is generated when the corresponding products are damaged or have reached the end of their service life.

In the past, attempts have therefore been made to recycle polyurethanes. European U.S. Pat. 1,976,719 B1, for example, describes a process in which a polyurethane resin is hydrolyzed by bringing it into contact with only water at high temperatures.

The object of the invention is to provide an improved method.

The invention results from the features of the independent claims. Advantageous further developments and embodiments are the subject of the dependent claims.

In the context of the invention, plastic material is understood to mean a material that includes plastic, ranging from pure plastic to mixtures containing plastic. The term “plastic” is used in the usual sense and refers to a synthetically produced material, for example a material produced as part of an organic synthesis, such as a polymer produced from one or more different monomers by polymerization, polyaddition and/or polycondensation. Plastics are classified according to a usual classification into thermosets, thermoplastics, elastomers and thermoplastic elastomers. Well-known examples of plastics are polyethylene, polycarbonate, polyacrylic, polymethacrylic, polyacrylamide, polystyrene, acrylonitrile-butadiene rubber, styrene-butadiene rubber, chloroprene rubber, butadiene rubber and ethylene-propylene-diene rubber, as well as polyurethane, whereby in special embodiments it is provided that the plastic material only comprises hydrolyzable plastics as plastics, for example, in addition to polyurethanes, also polyesters, polyamides and/or polycarbonates. Natural rubber previously used for a technical task, for example in the context of mattress production or chemically processed, for example vulcanized natural rubber, is also considered a plastic within the scope of the invention, but lignin, i.e., wood, is not. Depending on their original intended use, the plastics may contain other substances such as plasticizers, microbicidal substances, antioxidants, stabilizers, for example against UV light, flame retardants, dyes or residues of polymerization initiators. Plastics also include those that are not based on petroleum-based starting products, but are produced from renewable raw materials as part of a concept of sustainability and renewability, either as part of a chemical synthesis or as part of biotechnological or microbiological processes using appropriately designed enzymes or production organisms. The plastic-containing mixtures mentioned at the beginning are either mixtures of pure plastics, or mixtures that also contain one or more non-plastics such as metal, ceramic or glass. Preferably, the plastic(s) in such mixtures, which also comprise non-plastics, represents the relatively largest proportion by mass or volume, for example at least 67%, at least 75%, at least 80%, at least 90%, at least 95%, at least 98% or at least 99%. Preferably, there are no non-plastics in the plastic material, whereby methods for reducing these are known to the person skilled in the art and include, for example, manual removal of non-plastics, magnetic removal of magnetic metals or metal alloys, or the separation of plastics and optionally other materials of similar density due to density differences between materials of different densities, for example via air sifting or shaking or vibrating devices. Within the plastic material, polyurethane makes up the largest proportion by mass, preferably more than 60%, for example at least 65%, at least 70%, at least 75%, at least 80%, at least 85%, at least 90%, or at least 95%, and therefore represents the predominant main component. For example, discarded polyurethane mattresses often contain correspondingly small amounts of polyethylene or polypropylene, which usually come from the cover materials.

The plastic material used in the process contains polyurethane and optionally also one or more hydrolyzable plastics selected from polyesters, polyamides or polycarbonates, or consists of polyurethanes and optionally also polyesters, polyamides or polycarbonates and/or a mixture thereof. According to a particular embodiment, the plastic material consists of polyurethane or a polyurethane mixture, or consists of polyurethane and polyester or a polyester mixture, for example of polyethylene terephthalate or a polyethylene terephthalate mixture, or consists of a polyurethane/polyolefin composite material, wherein the polyurethane in the composite preferably has a proportion of at least 50 percent by mass. Polyurethane makes up the largest proportion by mass of hydrolysable plastics, preferably more than 60%, for example at least 65%, at least 70%, at least 75%, at least 80%, at least 85%, at least 90%, or at least 95%, and is therefore the predominant main component. For example, the plastic material is mattresses or waste from mattress production, with the raw material containing polyurethane as a hydrolysable component. The polyurethane can in particular be in the form of foam, with the particular advantage of the process being that a starting material with a high volume (namely a foam that can be compressed to a certain extent but always tends to take up a large volume and therefore requires appropriately dimensioned first lines and reaction vessels) is reacted in the presence of a comparatively small volume of reaction medium, with a significantly smaller volume resulting after appropriate pressure and heat treatment. Essentially, a bulky solid, namely a foam, is converted into a more easily handled form with a significantly higher liquid content and a smaller volume, thus solving a major problem in the polyurethane waste and recycling industry.

One aspect of the invention relates to a continuous process for converting a plastic material containing at least one hydrolysable plastic, comprising the following steps: providing a reaction mixture, wherein the reaction mixture comprises a plastic material present as a solid and containing a polyurethane and also an aqueous medium, wherein in the reaction mixture the mass ratio between the water of the aqueous medium and polyurethane is not more than 0.6 to 1; further transporting the reaction mixture by means of a first screw conveyor arranged in a first line to a filling opening designed as a pressure lock of a reactor tapering at least in one end region, relative to the transport direction; further transporting the reaction mixture by means of a reactor screw conveyor arranged in the reactor at a pressure of >1 bar to 60 bar at a temperature of 180° C. to 270° C. to the end region of the reactor, further transferring the reaction mixture thus pressure- and heat-treated in the end region of the reactor via a removal opening designed as a pressure lock into a second line, further transporting the pressure- and heat-treated reaction mixture by means of a second screw conveyor arranged in the second line, further providing a heating zone within the second line with a temperature which is above the temperature prevailing in the reactor, further removing gaseous constituents in the evaporation zone via at least one degassing point and obtaining the reaction mixture which has been pressure- and heat-treated and freed of gaseous constituents in or after the evaporation zone. The reaction mixture can be partially or completely freed of the gaseous constituents.

The aqueous medium comprises or consists of water and may optionally contain a reaction additive.

The liquid phase and the solids contained can optionally be separated from the pressure- and heat-treated reaction mixture obtained, for example by centrifugation or filtration, and the solids obtained can optionally be dried.

The mass ratio between water in the aqueous medium and polyurethane in the plastic material is not more than 0.6 to 1, in particular not more than 0.5 to 1, for example 0.45 to 1, so that polyurethane is present in a clear excess in relation to the mass ratios. Larger amounts of aqueous medium are possible, but it was surprisingly found that good conversion rates can be achieved with the specified mass ratios. Accordingly, it is not necessary for the plastic material to be suspended in a coherent aqueous medium, it only needs to be moistened with it. With the aim of a resource-saving circular economy, reducing water—consumption is a significant advantage.

At the beginning of the process, the reaction mixture is transported by means of the first screw conveyor to the reactor's filling opening, which is designed as a pressure lock. An example of such pressure locks are the well-known double locks. Other examples are screw conveyors that convey material while compacting it, or screw conveyors that even have return elements that lead to local compaction of transported material, which in turn represents a pressure barrier and thus functions as a pressure lock. The volume of the reactor can, for example, range from the liter range to the cubic meter range to large-scale volumes of dozens of cubic meters or more.

After passing through the pressure lock, the polyurethane contained in the plastic material and initially present as a solid, as well as any other hydrolyzable plastics present therein, are converted into a liquid phase as the hydrolyzable plastics contained therein become increasingly converted due to the temperature and pressure conditions prevailing in the reactor in the presence of the aqueous medium, which optionally contains a reaction additive. Since the volume of the reaction mixture is mainly attributable to the plastic material due to the low water content, the volume of the plastic material decreases progressively as the transport progresses towards the discharge opening. Consequently, a reactor that tapers at least in one end region can be used, which advantageously requires less heating power and less space with increasing tapering and the associated lower volume of the reaction mixture.

The process is carried out at a pressure in the range of >1 bar to 60 bar, i.e. at an overpressure, based on an atmospheric pressure of 1 bar, such as 5 to 50 bar, 10 to 40 bar, or 20 to 30 bar, for example at about 10, 15, 20, 25, 30, 35, 40, 45, 50, 55 or 60 bar. The temperature during the process is in a range of 180° C. to 270° C., such as 180° C. to 250° C., such as 190°C. to 245° C., 200° C. to 240° C., 210° C. to 235, or 215°C. to 230°C., such as 185, 190, 200, 210, 215, 220, 225, 230, 235, 240 or 250° C. Preferably, a target temperature and a target pressure are specified, although it is understandable to the person skilled in the art that during the implementation of a process the actual values can deviate from the target values or fluctuate around them and can be controlled or adjusted accordingly if necessary. The temperature and pressure can be actively regulated. According to a special development, only the temperature is actively regulated, with the pressure being passively adjusted as an equilibrium pressure based on the current temperature of the aqueous reaction mixture in a predetermined reaction volume. The speed of transport from the filling opening to the removal opening can be adjusted depending on the achieved reduction in the solids content, for example reduced if an optional sample removal shows that the solids content in the pressure and heat-treated reaction mixture is too high. Non-limiting examples of the duration of the pressure and heat treatment are periods of, for example, 1 to 8 hours, for example 1.5 to 6 hours, such as 2 to 4 hours, for example 1, 2, 3, 4, 5, 6, 7, or 8 hours, ±0 to 59 minutes. For example, the duration of the pressure and heat treatment is 45 to 250 minutes, in particular 45 to 240 minutes. However, it is clear to the person skilled in the art that, in order to adapt to particular reaction processes, the times can be adjusted accordingly, for example they can be less than 1 hour if the reaction takes place very quickly, or more than 8 hours if the reaction takes place very slowly. The process is carried out continuously, with the degree of reaction being determined if necessary by taking samples from the reactor and the time being adjusted accordingly. The reaction takes place in the absence of air. It can take place in particular under anaerobic conditions. Suitable measures for generating anaerobic conditions are known to those skilled in the art, for example by expelling oxygen from the aqueous reaction mixture by heating, by generating steam and/or by flushing with an inert gas such as nitrogen.

The taper of the reactor in the transport direction can be continuous, so that the cross section between the filling opening and the removal opening constantly decreases, for example decreases linearly. As a further alternative, it can be provided that the cross section of the reactor after the filling opening initially remains constant. This takes into account the fact that the conversion must first start after the reaction mixture has been introduced into the reactor and thus a smaller reduction in the volume of the solid is to be expected in the filling opening. The cross section of the reactor can then be reduced at a certain distance from the filling opening. In fact, it has surprisingly been found that even with a small proportion of aqueous medium, the conversion of solids into liquids begins after a short transport in the reactor and this is accompanied by a reduction in the volume of solids. Accordingly, it can be provided, for example, that the first 5 to 20% of the length of the reactor, such as 10 to 15% of the length, have a constant cross section and the remaining portion has a taper, for example a linear taper. According to one embodiment, the transport direction in the reactor follows gravity.

After passing through the reactor, the pressure- and heat-treated reaction mixture is transferred to a second line via the discharge opening designed as a pressure lock. At this point, the reaction mixture has a significantly lower volume fraction of solids, and possibly no solids, compared to the reaction mixture initially used. Instead, the pressure- and heat-treated reaction mixture is a liquid or a liquid with solids. One aim of the process is to reduce the volume of the solids used, consisting of the plastic material in solid form and possibly other solids. For example, a reduction of up to 95%, up to 90%, or 4 to 50%, such as 5 to 30%, for example 7 to 25% or 10 to 15%, is possible, based on the volume of the solids used. A high reduction is possible in particular with foams.

Another optional aim of the process is the further use of the products obtained during the reaction. In order to provide a more uniform pressure- and heat-treated reaction mixture, an evaporation zone with a temperature that is above the temperature prevailing in the reactor is therefore provided within the second line. The evaporation zone is therefore suitable for removing components whose boiling point is above the temperature prevailing in the reactor but below the temperature prevailing in the evaporation zone. This is done via one or more degassing points, where gaseous components that have a corresponding boiling point are removed. If necessary, known cold traps, vacuum traps and/or valves or control devices for maintaining pressure gradients can be used at the degassing points. The gaseous components removed can be used separately. The pressure- and heat-treated reaction mixture, which is now freed from gaseous components with a boiling point above the temperature prevailing in the reactor, is recovered in or after the evaporation zone.

For improved implementation, the plastic material is preferably used in a comminuted state, particularly if it comprises plastic that does not swell in water. Standard comminution processes can be used here, for example the plastic material can be cut, torn, grated into flakes, shredded, granulated, ground or pulverized, if necessary after a prior reduction in temperature to increase brittleness. Non-limiting examples of the size of the plastic particles used are approximately 0.5 cm³ to 10 cm³ (0.5 ml to 10 ml), such as approximately 1 cm³ to 5 cm³, particularly for porous plastic material or plastic material with a large surface area, or plastic particles with a diameter, measured at the largest point, of a maximum of approximately 10.5, 2, 1, 0.5, 0.1, 0.05 or 0.01 millimeters.

According to one embodiment, the temperature in the evaporation zone is greater than or equal to the boiling point of nitrogen-containing components and lower than the boiling point of high-boiling components. Such nitrogen-containing components occur in particular when nitrogen-containing plastics are contained in the plastic material, i.e., also in the case of polyurethanes. The nitrogen-containing components are usually diamines or their degradation products or reaction products. By removing these nitrogen-containing components, on one hand, they can be used separately and on the other hand, a more uniform pressure- and heat-treated reaction mixture can be provided. In particular, a reaction mixture that is depleted of nitrogen-containing components or freed of them is better suited for any subsequent processing steps, for example pyrolysis.

In one embodiment, it is provided that the temperature of the evaporation zone is 265° C. to 300° C., in particular 265° C. to 280° C., such as 270° C. to 280° C. At these temperature—ranges, it was determined that significant proportions of nitrogen-containing constituents can be advantageously partially or completely removed from the pressure- and heat-treated reaction mixture via the at least one degassing point. In particular, it was determined that at a temperature in the evaporation zone of 265° C. to 280° C., diaminotoluenes could be removed from the reaction mixture in gaseous form via the degassing point. Likewise advantageously, the remaining pressure- and heat-treated reaction mixture partially or completely freed of nitrogen-containing constituents in this way contains constituents that boil at a higher temperature. Without wishing to be bound to a theory, it is assumed that, given the polyurethane present in the initially used reaction mixture, it is polyols and their degradation products and/or conversion products.

In one embodiment, a dewatering zone is arranged in the second line upstream of the evaporation zone, in which the temperature is above the boiling point of water and below the boiling point of nitrogen-containing components. Accordingly, gaseous water vapor can be removed via one or more water vapor removal points in the dewatering zone, thus reducing the water content of the pressure- and heat-treated reaction mixture. This makes it possible to provide a pressure- and heat-treated reaction mixture which is also partially or completely dewatered and is therefore advantageously in the more easily handled form of a solid. If necessary, cooling traps, vacuum traps and/or valves or control devices for maintaining pressure gradients can be used at the water vapor removal points.

The pressure in the second line can correspond to the pressure in the reactor or can be atmospheric pressure. In the former case, a further pressure lock can be provided at the end of the second line to convert to atmospheric pressure. In the latter case, the pressure is reduced to atmospheric pressure through the reactor's discharge opening, which is designed as a pressure lock. Another option is to use one or more further pressure locks between the discharge opening, which is itself designed as a pressure lock, and the end of the second line to gradually reduce the pressure.

According to one embodiment, in a second line in which atmospheric pressure prevails, the temperature prevailing in the second line corresponds at least to the boiling point of water at the corresponding atmospheric pressure. This advantageously enables the reduction of the water content when a dewatering zone with at least one degassing point is provided. In a further development, it is provided that the temperature in the dewatering zone is below the boiling point of nitrogen-containing components, wherein the dewatering zone is followed by an evaporation zone with a temperature above the boiling point of nitrogen-containing components, and wherein nitrogen-containing components can be removed from the pressure- and heat-treated and partially or completely freed of water reaction mixture via one or more corresponding degassing points in the evaporation zone.

According to one embodiment, in the reaction mixture with which the first line is fed, the volume ratio between solid and aqueous medium is 100:1 to 5:1, for example 75:1 to 10:1, 30:1 to 20:1, such as 25:1. In this respect, it is clear that there is not predominantly an aqueous medium in which the plastic material is suspended as a solid (and possibly other solids), but rather the predominant volume fraction is made up of the plastic material, which is merely moistened with a significantly smaller volume of aqueous medium. For example, it can be provided that 0.05 to 0.2 volume fractions of aqueous medium are provided per volume fraction of polyurethane foam or per volume fraction of solid. Accordingly, at the beginning of the reaction, only a plastic material moistened with an aqueous medium is present in the reaction mixture, i.e., essentially a solid moistened with the reaction medium, whereby as the transport progresses in the transport direction, the reaction converts solid with a high-volume requirement into a liquid phase with a lower volume requirement.

The ratio of the cross-sectional area of the reactor before tapering to the cross-sectional area at maximum tapering can, according to special embodiments, be 10:1, in particular 5:1, in particular 2:1. This advantageously takes account of expected reductions in the volume of the solids.

According to one embodiment, the pressure- and heat-treated reaction mixture obtained is introduced directly or indirectly into a pyrolysis plant to carry out pyrolysis. The principle of pyrolysis itself is known and is based on a thermochemical conversion of substances in the absence of external oxygen, usually in a temperature range of 150° C. to 800° C. In the context of the process described here, the highest temperature prevailing in the reactor or in the downstream second line is preferred as the lower limit of the temperature range, such as a temperature range of 265° C. to 800° C. For example, this is a temperature range of 265° C. to 500° C. or 300° C. to 500° C. Another example of a temperature range is the range from 700° C. to 800° C., in particular from 750° C. to 800° C., which is advantageously suitable for decomposing calcium carbonate present in the plastic material into calcium oxide and carbon dioxide and thus providing a calcium carbonate-poor or calcium carbonate-free pyrolysis coke as a product of the pyrolysis. The pyrolysis treatment is preferred over using the resulting pressure- and heat-treated reaction medium. Assuming that it essentially contains polyols and possibly conversion products, additional purification or separation steps are required to ensure sufficient quality for their further use. On the other hand, pyrolysis can advantageously obtain monomers of the polyols, which are assumed to have a higher qualitative purity compared to polyols.

According to a preferred embodiment, the pressure- and heat-treated reaction mixture, which is introduced directly or indirectly into a pyrolysis plant, is a reaction mixture from which gaseous components with a boiling point below the temperature prevailing in an evaporation zone have previously been partially or completely removed. In particular, according to the embodiments described here, it is possible to feed such a reaction mixture to pyrolysis which has a lower proportion of nitrogen-containing components or is free of such components. This makes it possible to provide pyrolysis products which in turn can be advantageously used further. In particular, liquid, gaseous and solid pyrolysis products can be obtained during pyrolysis. With regard to the liquid products, these are pyrolysis oils, which in turn can be fed to chemical cracking, in which high proportions of nitrogen-containing components would, however, be disruptive. The pyrolysis gas obtained can be used to generate electricity, whereby low proportions of nitrogen-containing components reduce the problem of nitrogen oxides being formed. Solid pyrolysis products, which are a type of pyrolysis coke, can be used for various purposes, for example as a substitute for carbon black or as petroleum coke that can also be used to generate electricity, so that low or no amounts of nitrogen-containing components are also advantageous here.

According to a particularly preferred embodiment, the pressure- and heat-treated reaction mixture which is introduced directly or indirectly into a pyrolysis plant has a low water content or is free of water because it was passed through a dewatering zone in which the water content was reduced before passing through the evaporation zone.

The reaction additive optionally contained in the aqueous medium is, according to one embodiment, selected from nitric acid, a carboxylic acid, urea and/or a biological material. Good conversion can be achieved with nitric acid. However, if a pressure- and heat-treated reaction mixture with a low proportion of nitrogen-containing components is desired, other reaction additives are preferred, since nitric acid provides additional nitrogen. In general, mineral acids such as hydrochloric acid or phosphoric acid, or mineral bases such as sodium hydroxide are less preferred, since chlorine, phosphorus and sodium components would be present in the pressure- and heat-treated reaction medium and could have a detrimental effect in the case of downstream pyrolysis or later uses of the pyrolysis products obtained. Alternative reaction additives with which good conversion can be achieved are carboxylic acids, for example in particular linear, saturated monocarboxylic acids such as formic acid, acetic acid, propionic acid, butyric acid or pentanoic acid, hexanoic acid, heptanoic acid; Dicarboxylic acids such as oxalic acid (ethanedioic acid), malonic acid (propanedioic acid), succinic acid (butanedioic acid), glutaric acid (pentanedioic acid), adipic acid (hexanedioic acid), malic acid (2-hydroxybutanedioic acid), tartaric acid (2,3-dihydroxybutanedioic acid); and tricarboxylic acids such as 3-carboxy-2-oxo-pentanedicarboxylic acid (oxalsuccinic acid), propane-1,2,3-tricarboxylic acid, citric acid (2-hydroxypropane-1,2,3-tricarboxylic acid) and isocitric acid (1-hydroxypropane-1,2,3-tricarboxylic acid). Another reaction additive is urea. Based on the total mass of the aqueous medium, the proportion of urea in the aqueous medium is, for example, 1 to 45 percent by mass, in particular 1 to 20 percent by mass, for example 1 to 10 percent by mass, such as 1 to 7 percent by mass, for example 1.5 to 5 percent by mass, 1.5 to 4 percent by mass, 2 to 4 percent by mass, 2.5 to 3.5 percent by mass, or 3 percent by mass. Examples of further ranges or further concentrations are 5 to 10 percent by mass, 1 percent by mass, 5 percent by mass, 7.5 percent by mass and 10 percent by mass. From the point of view of the relationship between the amount of urea to be used and the degree of degradation of polyurethane achieved, a range between 1 percent by mass and 10 percent by mass is preferred, for example 2.5 to 10 percent by mass, 2 percent by mass to 7.5 percent by mass, such as 3 percent by mass to 5 percent by mass.

According to a particular embodiment, the aqueous medium comprises 2.5 to 10 percent by mass of urea, the duration of the pressure and heat treatment is preferably 45 to 250 minutes, in particular 45 to 240 minutes. The ratio between urea-containing aqueous medium and polyurethane-containing plastic material can be, for example, 0.2 ml/g to 5 ml/g, in particular 0.4 ml/g to 5 ml/g.

The reaction additive can also be a biological material. In the context of the invention, biological material is understood to mean plant, animal or microorganism material, for example complete plants or parts of plants such as wood, leaves, stems, roots or seeds, such as gardening waste or grass cuttings. The biological material is preferably plant material. According to a particular embodiment, the biological material is wood, in particular chopped wood, for example in the form of sawdust, wood chips or shredded wood. It has been found that with plant material, for example with wood, after appropriate dewatering in a dewatering zone, a free-flowing solid can be obtained which is, for example, well suited to being transported via screw conveyors. Subsequent use, for example transport to and introduction into pyrolysis plants, is thereby made considerably easier. The presence of plant material in the reaction mixture accordingly leads to a significant improvement. The mass ratio of plastic material to biological material, in particular plant material, can be, for example, 3:1 to 1.5:1, such as 2:1. Particularly at mass proportions of one third or more, based on the total mass of plastic material and biological material, for example 33 to 50 mass percent, in particular 33 to 45 mass percent, such as 34 to 40 mass percent, very free-flowing solids were obtained in the pressure- and heat-treated reaction medium after passage through the dewatering zone.

The aforementioned reaction additives can be used individually or in any mixtures of two or more of the respective aforementioned representatives.

Examples of mixing ratios of the plastic material with an aqueous medium containing a reaction additive are 2 to 25 liters of plastic material moistened with at least 0.08 to 1 liter of aqueous medium. The aqueous medium can contain 3 to 50 percent by mass, in particular 4 to 40 percent by mass, for example 4 to 20 percent by mass of nitric acid, carboxylic acid, a dicarboxylic acid, a tricarboxylic acid and/or urea. In the case of the addition of a biological material, it can be provided that the plastic material takes up 55 to 95 percent by volume, in particular 67 to 95 percent by volume, and the biological material accordingly 5 to 45 percent by volume, in particular 5 to 33 percent by volume. The biological material can be mixed with the plastic material and then the aqueous medium added, or first mixed with the aqueous medium and then with the plastic material, or all three components can be mixed simultaneously.

If the plastic material and/or the hydrolysable plastic contained therein is a compressible plastic, in particular a foam, the volumes stated refer to the uncompressed plastic.

According to one embodiment, one or more pressure barriers are arranged in the first line and/or the second line. When a pressure gradient is created, these advantageously serve to prevent the reaction mixture from being transported in the opposite direction to the desired transport direction.

According to one embodiment and with respect to the transport direction, the reactor screw conveyor in the reactor can extend only over a part of the reactor, for example over that part of the reactor vessel in which a high proportion of solids is still present.

According to another embodiment, the reactor screw conveyor extends with a corresponding taper into the tapered end region of the reactor, thereby advantageously ensuring transport of the reaction medium to the removal opening over the entire transport path.

The feed rate of the reactor feed screw can be controlled. This advantageously opens up the possibility of influencing the residence time of the reaction mixture in the reactor. In the event that a lower conversion takes place than originally assumed, for example, the conveying speed can be reduced in order to achieve a longer residence time and thus a higher conversion. In the event that the conversion takes place faster than originally assumed, the conveying speed can be increased and thus the throughput of the reactor can be increased.

According to one embodiment, it is provided that water obtained after removal of solids from the reaction mixture obtained after pressure and heat treatment and freed of gaseous components, and/or water obtained from gaseous water extracted via a steam extraction point, is added to a reaction mixture to be provided, optionally after addition of reaction additive. A circulating process is thus advantageously carried out in which water from an aqueous medium already used is at least partially returned to the continuous process, thus reducing resource consumption.

A further aspect of the invention relates to a device for carrying out a method as described herein. The device comprises a first line with a first screw conveyor arranged therein, the first line opening into a reactor via a filling opening designed as a pressure lock, a reactor screw conveyor being arranged in the reactor and the reactor, which is tapered at least in one end region, opening into a second line by means of a removal opening designed as a way of expressing, in which a second screw conveyor is arranged, an evaporation zone being provided in the second line in which a higher temperature can be specified than in the reactor, and the second line having a degassing point in the evaporation zone via which gaseous components can be removed from the second line. Such a device is accordingly suitable for transporting a reaction mixture as described herein, namely a reaction mixture comprising a plastic material which contains polyurethane and is in the form of a solid, and further comprising an aqueous medium, optionally containing a reaction additive with which the plastic material is moistened, via the first screw conveyor of the first line to the filling opening, designed as a pressure lock, of the reactor which tapers at least in one end region.

After entering the reactor via the filling opening, the reaction mixture is exposed to the pressure and temperature conditions prevailing there and converted, and can be transferred to the second line via the removal opening, designed as a pressure lock, in the end region of the reactor. By means of the second screw conveyor arranged in the second line, the pressure- and heat-treated reaction mixture can be transported to the evaporation zone, in which gaseous components can be removed via at least one degassing point. The pressure- and heat-treated reaction mixture thus depleted of gaseous components can be removed after further transport in the second line, for example for a pyrolysis treatment, or can, for example, be fed directly into a pyrolysis plant, which optionally represents an extension of the device described herein.

In a further embodiment of the device, a dewatering zone is arranged in the second line before the evaporation zone, in which the temperature is above the boiling point of water and below the boiling point of nitrogen-containing components and in which gaseous water can be removed via a steam extraction point. The reaction mixture remaining in the second line after the removal of steam, which has been pressure- and heat-treated and depleted of water or freed of water, is then partially or completely freed of remaining gaseous components in the evaporation zone, preferably gaseous nitrogen-containing components. The reaction mixture which then remains, which has been pressure- and heat-treated, depleted of water or freed of water and depleted of other gaseous components or freed of these, can in turn be removed and, for example, fed directly or indirectly to pyrolysis.

Reference is made to implicit disclosures regarding the device made in connection with the method and vice versa.

Further advantages, features and details emerge from the following description, in which—if necessary, with reference to the figures, at least one embodiment is described in detail. Identical, similar and/or functionally identical parts are provided with the same reference numerals.

It shows:

FIG. 1: a schematic sectional view of a reactor with an evaporation zone,

FIG. 2: a schematic representation of a reactor with an evaporation zone and a dewatering zone.

The representations in the figures are schematic, not necessarily to scale and show only essential components.

### EXAMPLES

### Example 1: Preparation of a Reaction Mixture

In a pilot test, a polyurethane foam mixture obtained from mattresses that had reached the end of their life cycle was used as the plastic material. The mattresses, which had a density of about 40 kg per cubic meter, were shredded and the resulting material was a mixture of standard ether foams, HR foams and viscoelastic foams. 400 g of the resulting material was placed in a 10 l bucket, which was thereby filled to about 85%.

To the shredded material, 100 g of fine sawdust and 100 g of shredded wood chippings were added as biological material, assuming a density of about 700 kg per cubic meter. The plastic material was mixed with the biological material, after which the bucket was still about 85% full.

The aqueous medium used was 150 ml of the liquid phase of pressure- and heat-treated reaction medium from a previous experiment in which plant material had been added as a reaction additive and which had assumed a pH value of 4 during the reaction. This aqueous medium was mixed with the mixture of plastic material and biological material, thereby moistening it. The volume of the reaction mixture obtained in this way, i.e. a mixture of shredded mattress material and biological material moistened with reaction medium, was approximately 8.6 litres.

### Example 2: Loading a Reactor

A Büchi reactor pressure vessel was used as the reactor, which had a volume of 10 litres and was designed for a maximum pressure of 60 bar, whereby the prepared reaction mixture was placed in a stainless steel inner bucket (inliner), which in turn was placed in the Büchi reactor pressure vessel. The Büchi reactor pressure vessel was then sealed pressure-tight with a lid.

### Example 3: Implementation of the Conversion

The aim of this experiment was to determine the reduction in the proportion of solids as a result of the reaction. The reactor was first heated to a jacket temperature of 260° C., which was reached after approximately 6 to 10 minutes, then held at 260° C. for 1 hour and then at 240° C. for 2 hours, during which an equilibrium pressure was established in the reactor. The pressure vessel was then actively and rapidly cooled to ambient temperature.

### Example 4: Determination of the Remaining Solid Volume

After completion of the reaction, the liquid phase of the pressure- and heat-treated reaction medium was drained off to determine the volume of the remaining solid. The original components could no longer be recognized in the remaining solid; instead, it was a brownish-black mass whose volume was determined to be 1.2 litres. Accordingly, the volume of the solid had been reduced to about 14% of the initial volume as a result of the reaction

In other tests in which urea solution was used as a reaction additive, complete liquefaction was determined. Accordingly, reductions in the solid volume of 90-95%±5% are realistically achievable.

### Example 5

In another experiment, 500 g of a shredded mattress material was added to the Büchi reactor pressure vessel with 150 mm of water containing 40 g of citric acid and 50 g of 96% acetic acid. The mattress material used essentially comprises polyurethane foam as well as portions of polyethylene and polypropylene.

This reaction mixture was heated to 260° under equilibrium pressure for 60 minutes and then kept at 250° for 120 minutes.

After cooling the reaction mixture that had been subjected to pressure and heat in this way, solid particles of polyethylene/polypropylene floated on the liquid phase due to their lower density and could be easily separated mechanically.

After separation of the liquid phase of the pressure- and heat-treated reaction mixture, a blackish material remained, which was dried, resulting in a volume reduction of about 95% compared to the volume of the originally used plastic material.

### Figure Description

FIG. 1 shows a schematic representation of a reactor 16. Reaction mixture, which comprises a plastic material in solid form and containing at least one polyurethane and also an aqueous medium, optionally containing a reaction additive, is filled into a first line 10 via a feed hopper (not further designated). In the line 10, the reaction mixture is transported by means of a first screw conveyor 12 to a filling opening 14 of a reactor 16 designed as a pressure lock and is introduced into the reactor 16 via the filling opening. The pressure within the reactor 16 is >1 bar to 60 bar at a temperature of 180° C. to 270° C. The reaction mixture is transported in the direction of an end region of the reactor 16 by means of a reactor screw conveyor 18 arranged in the reactor 16. The conversion of the polyurethane and any other hydrolyzable plastics contained in the plastic material in the reactor 16 reduces the volume fraction of solids in the reaction mixture, which is why the reactor 16 can taper towards the end region. The reaction mixture is introduced into a second line 22 via a discharge opening 20 of the reactor 16 designed as a pressure lock and is transported by means of a second screw conveyor 24 located therein. In the second line 22 there is an evaporation zone 26 in which the temperature is higher than the temperature prevailing in the reactor 16. Gaseous—components can be removed from the second line 22 at this temperature via a degassing point 28, so that a reaction mixture correspondingly depleted in gaseous components and which has been pressure- and heat-treated is transported downstream of the discharge opening within the second line 22 and can be recovered. Details such as motors for driving the first screw conveyor 12, the second screw conveyor 24, or the reactor screw conveyor 18, or heating devices for heating the reactor 16 or the evaporation zone 26 are not shown.

FIG. 2 shows a further schematic representation of a reactor 16 which corresponds to the reactor 16 shown in FIG. 1, but additionally has a dewatering zone 30 in the second line 22. The dewatering zone 30 is located upstream of the evaporation zone 26 in relation to the transport direction of the reaction mixture to be transported. The dewatering zone 30 is designed to assume a temperature which is above the temperature prevailing in the reactor 16, but below the temperature prevailing in the subsequent evaporation zone 26. The temperature prevailing in the dewatering zone 30 is selected such that water evaporates under the corresponding pressure and temperature conditions.

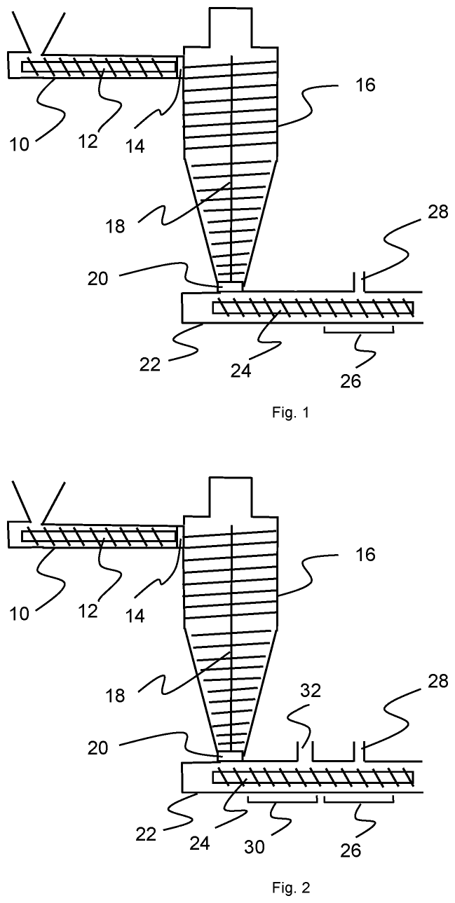

The embodiments mentioned here and/or individual elements thereof can be freely combined with one another. Although the invention has been illustrated and explained in more detail by preferred embodiments, the invention is not restricted by the disclosed examples and other variations may be derived from them by the person skilled in the art without departing from the scope of protection of the invention. It is therefore clear that a large number of possible variations exist. It is also clear that embodiments mentioned by way of example really only represent examples that are not to be understood in any way as a limitation of the scope of protection, the application possibilities or the configuration of the invention. Rather, the preceding description and the description of the figures enable the person skilled in the art to implement the exemplary embodiments in concrete terms, whereby the person skilled in the art, with knowledge of the disclosed inventive concept, can make a variety of changes, for example with regard to the function or arrangement of individual elements mentioned in an exemplary embodiment, without departing from the scope of protection defined by the claims and their legal equivalents, such as further explanations in the description.

### LIST OF REFERENCE SYMBOLS

10 First line
12 First screw conveyor
14 Filling opening
16 Reactor
18 Reactor screw conveyor
20 Removal opening
22 Second line
24 Second screw conveyor
26 Evaporation zone
28 Degassing point
30 Dewatering zone
32 Steam extraction point

1. A continuous process for the conversion of a plastic material containing a polyurethane, comprising the following steps:
providing a reaction mixture, wherein the reaction mixture comprises
a plastic material in solid form and containing a polyurethane, and further
an aqueous medium
wherein in the reaction mixture the mass ratio between the water of the aqueous medium and polyurethane is not more than 0.6 to 1,
transporting the reaction mixture by means of a first screw conveyor arranged in a first line to a pressure lock formed filling opening of a reactor tapering at least in one end region, relative to the transport direction,
transporting the reaction mixture by means of a reactor screw conveyor arranged in the reactor vessel at a pressure of >1 bar to 60 bar at a temperature of 180° C. to 270° C. to the end region of the reactor,
in the end region of the reactor, transferring the reaction mixture thus pressure-treated and heat-treated via a discharge opening designed as a pressure lock into a second line,
transporting the pressure- and heat-treated reaction mixture by means of a second screw conveyor arranged in the second line,
providing within the second line an evaporation zone with a temperature which is higher than the temperature prevailing in the reactor,
in the evaporation zone, removal of gaseous components via at least one degassing point and in or after the evaporation zone, recovery of the reaction mixture which has been pressure- and heat-treated and freed of gaseous components.

2. The process according to claim 1, characterized in that the temperature in the evaporation zone is greater than or equal to the boiling point of nitrogen-containing components and is lower than the boiling point of high-boiling components.

3. The process according to claim 1, characterized in that the temperature in the evaporation zone is 265° C. to 300° C.

4. The process according to claim 1, characterized in that a dewatering zone is arranged in the second line upstream of the evaporation zone, in which the temperature is above the boiling point of water and below the boiling point of nitrogen-containing components and in which gaseous water can be removed via a water vapor removal point.

5. The process according to claim 1, characterized in that atmospheric pressure prevails in the second line and the temperature corresponds at least to the boiling point of water at atmospheric pressure.

6. The process according to claim, characterized in that the volume ratio between solid and aqueous medium is 100:1 to 5:1.

7. The process according to claim 1, characterized in that the ratio of the cross-sectional area of the reactor vessel before the taper to the cross-sectional area at maximum taper is 10:1, in particular 5:1, in particular 2:1.

8. The process according to claim 1, characterized in that the reaction mixture obtained, which has been pressure- and heat-treated and optionally depleted of gaseous components with a boiling temperature below the temperature prevailing in the evaporation zone, is introduced directly or indirectly into a pyrolysis plant for carrying out a pyrolysis.

9. The process according to claim, characterized in that the aqueous medium contains a reaction additive which is selected from nitric acid, a carboxylic acid, a dicarboxylic acid, in particular adipic acid, a tricarboxylic acid, in particular citric acid, and/or urea and/or a biological material.

10. The process according to claim 9, characterized in that the reaction additive is a plant material.

11. The process according to claim 1, characterized in that one or more pressure barriers are arranged in the first line and/or in the second line.

12. The process according to claim 1, characterized in that the reactor screw conveyor extends with a corresponding taper into the tapered end region of the reactor vessel.

13. The process according to claim 1, characterized in that water,
obtained after removal of solids from the obtained pressure- and heat-treated reaction mixture as well as of gaseous components, and/or
water obtained from gaseous water extracted via a steam extraction point,
is added to a reaction mixture to be provided, optionally after addition of reaction additive.

14. A device for carrying out a process according to claim 1, comprising a first line with a first screw conveyor arranged therein, the first line opening into a reactor via a filling opening designed as a pressure lock, wherein a reactor screw conveyor is arranged in the reactor and wherein the reactor, which is tapered at least in one end region, by means of a removal opening designed as a pressure lock opens into a second line, in which a second screw conveyor is arranged, an evaporation zone being provided in the second line, in which a higher temperature than in the reactor can be specified, and the second line having a degassing point in the evaporation zone, via which gaseous components can be removed from the second line.

15. The device according to claim 14, characterized in that in the second line upstream of the evaporation zone there is arranged a dewatering zone, in which the temperature is above the boiling point of water and below the boiling point of nitrogen-containing components and in which gaseous water can be removed via a water vapor removal point.

16. A continuous process for the conversion of a plastic material containing a polyurethane, comprising the following steps:
providing a reaction mixture, wherein the reaction mixture comprising
a plastic material in solid form and containing a polyurethane, and further
an aqueous medium
wherein in the reaction mixture the mass ratio between the water of the aqueous medium and polyurethane is not more than 0.6 to 1,
transporting the reaction mixture by means of a first screw conveyor arranged in a first line to a pressure lock formed filling opening of a reactor tapering at least in one end region, relative to the transport direction,
transporting the reaction mixture by means of a reactor screw conveyor arranged in the reactor vessel at a pressure of >1 bar to 60 bar at a temperature of 180° C. to 270° C. to the end region of the reactor,
in the end region of the reactor, transferring the reaction mixture thus pressure-treated and heat-treated via a discharge opening designed as a pressure lock into a second line,
transporting the pressure- and heat-treated reaction mixture by means of a second screw conveyor arranged in the second line,
providing within the second line an evaporation zone with a temperature which is higher than the temperature prevailing in the reactor,
in the evaporation zone, removal of gaseous components via at least one degassing point and in or after the evaporation zone, recovery of the reaction mixture which has been pressure- and heat-treated and freed of gaseous components,
wherein the temperature in the evaporation zone is greater than or equal to the boiling point of nitrogen-containing components and is lower than the boiling point of high-boiling components, and wherein the temperature in the evaporation zone is 265° C. to 300° C.

17. A continuous process for the conversion of a plastic material containing a polyurethane, comprising the following steps:
providing a reaction mixture, wherein the reaction mixture comprising
a plastic material in solid form and containing a polyurethane, and further
an aqueous medium
wherein in the reaction mixture the mass ratio between the water of the aqueous medium and polyurethane is not more than 0.6 to 1,
transporting the reaction mixture by means of a first screw conveyor arranged in a first line to a pressure lock formed filling opening of a reactor tapering at least in one end region, relative to the transport direction,
transporting the reaction mixture by means of a reactor screw conveyor arranged in the reactor vessel at a pressure of >1 bar to 60 bar at a temperature of 180° C. to 270° C. to the end region of the reactor,
in the end region of the reactor, transferring the reaction mixture thus pressure-treated and heat-treated via a discharge opening designed as a pressure lock into a second line,
transporting the pressure- and heat-treated reaction mixture by means of a second screw conveyor arranged in the second line,
providing within the second line an evaporation zone with a temperature which is higher than the temperature prevailing in the reactor,
in the evaporation zone, removal of gaseous components via at least one degassing point and in or after the evaporation zone, recovery of the reaction mixture which has been pressure- and heat-treated and freed of gaseous components,
wherein the temperature in the evaporation zone is greater than or equal to the boiling point of nitrogen-containing components and is lower than the boiling point of high-boiling components, and
wherein the aqueous medium contains a reaction additive which is selected from nitric acid, a carboxylic acid, a dicarboxylic acid, in particular adipic acid, a tricarboxylic acid, in particular citric acid, and/or urea and/or a biological material.

18. A continuous process for the conversion of a plastic material containing a polyurethane, comprising the following steps:
providing a reaction mixture, wherein the reaction mixture comprising
a plastic material in solid form and containing a polyurethane, and further
an aqueous medium
wherein in the reaction mixture the mass ratio between the water of the aqueous medium and polyurethane is not more than 0.6 to 1,
transporting the reaction mixture by means of a first screw conveyor arranged in a first line to a pressure lock formed filling opening of a reactor tapering at least in one end region, relative to the transport direction,
transporting the reaction mixture by means of a reactor screw conveyor arranged in the reactor vessel at a pressure of >1 bar to 60 bar at a temperature of 180° C. to 270° C. to the end region of the reactor,
in the end region of the reactor, transferring the reaction mixture thus pressure-treated and heat-treated via a discharge opening designed as a pressure lock into a second line,
transporting the pressure- and heat-treated reaction mixture by means of a second screw conveyor arranged in the second line,
providing within the second line an evaporation zone with a temperature which is higher than the temperature prevailing in the reactor,
in the evaporation zone, removal of gaseous components via at least one degassing point and in or after the evaporation zone, recovery of the reaction mixture which has been pressure- and heat-treated and freed of gaseous components,
wherein a dewatering zone is arranged in the second line upstream of the evaporation zone, in which the temperature is above the boiling point of water and below the boiling point of nitrogen-containing components and in which gaseous water can be removed via a water vapor removal point, and
wherein the aqueous medium contains a reaction additive which is selected from nitric acid, a carboxylic acid, a dicarboxylic acid, in particular adipic acid, a tricarboxylic acid, in particular citric acid, and/or urea and/or a biological material.
